(19) United States
(12) Patent Application Publication
(10) Pub. No.: US 2016/0339741 A1
(43) Pub. Date: Nov. 24, 2016

(54) ABRASION CONTROLLED CASTER WHEEL

(71) Applicant: Thomas A. Redington, Town & Country, MO (US)

(72) Inventor: Thomas A. Redington, Town & Country, MO (US)

(21) Appl. No.: 15/153,462

(22) Filed: May 12, 2016

Related U.S. Application Data
(60) Provisional application No. 62/163,214, filed on May 18, 2015.

(51) Int. Cl. B60B 33/00; B60B 33/02; B62B 3/14

(52) U.S. Cl. CPC B60B 33/006; B62B 3/1492; B60B 33/023; B60B 2200/432; B60B 2900/141; B60B 2900/321

(57) ABSTRACT

An abrasion controlled caster wheel is described. When a sideways force is applied to a rear of a grocery shopping or material cart either during normal operation or when gathered in the parking lot, the caster wheel, at the rear position of the cart, will redirect its direction of travel or change its mount rigidity rather than scraping sideways across the wheel circumference.

### CROSS REFERENCE TO RELATED APPLICATION

This application claims the benefit of U.S. Provisional Patent Application 62/163,214 filed May 18, 2015, which is hereby incorporated by reference.

### FIELD OF INVENTION

The present invention relates to an abrasion controlled caster wheel for use with shopping cart, grocery carts, material, and other carts.

### BACKGROUND

Typical rear caster wheels on a conventional grocery or shopping cart are of the rigid caster wheel design, controlling the direction of travel in either a straight forward or reverse direction. The typical rear caster wheels are in fixed position to provide forward or rear rolling movement. In the typical rear rigid caster wheel, little or no attention has been paid to the wear and abrasion caused on this wheel by forces that oppose the straight forward axis of the rear rigid caster wheel. Swivel caster wheels by themselves afford no directional control without having a rear rigid caster wheel to steer the grocery shopping cart. The use of four (4) swivel caster wheels (two front and two rear) is unsatisfactory, as the user would be required to constantly correct the direction of travel of the cart.

Use of the conventional grocery shopping carts causes one to desire a grocery shopping cart that is easier to control the direction without having to physically force the grocery shopping cart into the desired direction of travel. Physically forcing the grocery shopping cart into a direction contrary to the design of the direction of travel of the rear caster wheel causes unnatural and contrary wear to the circumference of the rear caster wheel.

Severe abrasion of a rear rigid caster wheel on the grocery shopping cart occurs not only in the store but out in the parking lot of the store as well. Shoppers complete their shopping tasks and push their grocery shopping carts out to their cars to unload their items. Shoppers will once again push or pull the rear of the grocery shopping cart sideways, causing the rear rigid caster wheel to abrade against the rough asphalt or concrete parking lot. Once the shopping cart is unloaded, most shoppers will make an effort to place the grocery shopping carts into a somewhat organized area in the parking lot for storage until a store employee can recover the grocery shopping carts and bring them back into the store. The store employee is charged with lining up the grocery shopping carts and stacking them within themselves in order to push or pull these grocery shopping carts back into the store. When forward directional control of a line of grocery carts is required, the store employee is required to force the rear of the grocery shopping carts left or right against the rotation of the wheel in order to change the direction of travel of a line of grocery carts. The rear rigid caster wheels all line up in a straight line, all pointing in the same rigid direction. This straight line of the rear rigid caster wheels forces a rigid control of the grocery shopping carts into a straight direction of travel unless redirected by the person retrieving the shopping carts. To change the direction of this line of grocery shopping carts, the store employee must again apply a force against the grocery shopping carts to change the rear rigid caster wheels direction. The force being applied against the rigid rear caster wheels causes the wheels to skid sideways against the very coarse asphalt and concrete parking lot. The roughness of either the asphalt or the concrete invariably causes a flat spot to occur on each and every one of the grocery shopping carts pushed sideways. Flat spots occur instantaneously when these rear rigid caster wheels are forced to move sideways against their rotation axis. These flat spots may cause the carts to track in a wrong direction, vibrate, and/or wobble.

### SUMMARY

An abrasion controlled caster wheel is described. The caster wheel may be used with a grocery, shopping, material, or other cart. When a sideways force is applied to a rear of the cart, utilizing the caster wheel, either during normal operation or when gathered in the parking lot, the caster wheel, at the rear position of the cart, will redirect its direction of travel or change its mount rigidity rather than scraping sideways across a wheel circumference of the caster wheel.

The abrasion controlled caster wheel includes a semi-rigid design. The abrasion controlled caster wheel includes a carriage base holding the caster wheel. The abrasion controlled caster wheel provides a momentary or temporary release that allows a rear caster wheel to rotate without abrading, eliminating premature circumferential wear of the wheel or bending of the carriage base. After the release, the caster wheel rotates and returns to settle back in its rigid position. The caster wheel described herein will allow the cart's rear caster wheel to turn into the direction of the applied sideways opposing force thus allowing the wheel to rotate without abrading or bending. The caster wheel easily controls the direction of the grocery shopping cart without causing unnatural and contrary wear to the circumference of the wheel. Controlling the direction of travel of the rear caster wheels of grocery shopping cart eliminates the severe abrasion from occurring by providing momentary release of rigidity of the rear caster wheels. This control of the rear caster wheel is accomplished using a direction control indexer mounted on the caster wheel.

A grocery cart is described having one set of wheels that swivel freely and having another set of wheels, such as the rear wheels, that are easily controlled or regulated in the straight forward or reverse position. The rear wheels allow release from the straight forward position by using the direction control indexer, when the user wants to alter the direction of the grocery shopping cart. Once released from the rigid position, the caster wheel rotates freely about a vertical axis into the forced direction of travel. This prevents abrasion of the rear wheels since the abrasion occurs on the conventional rigid shopping cart caster wheels when the caster wheels are not allowed to rotate into another direction other than straight/forward. Controlling abrasion on a rigid caster wheel requires being able to control the direction of travel for a momentary period of time without negating the original rear rigid caster wheel design characteristics and performance. The control needed is easily accomplished in such a way that the user of the grocery shopping cart merely applies a sideways force to the rear of the grocery shopping cart in the direction of desired travel. The rear rigid caster wheel is released from the rigid position by causing the direction control indexer to release from a detent position that holds the wheel in a straight position, allowing the rear rigid caster wheel to spin about the vertical axis of the carriage base. The abrasion of that wheel is eliminated by keeping the rolling moment of the wheel in-line with the force applied.

The user of the grocery cart is not required to touch the abrasion resistant wheel to make it disengage or reengage. The abrasion controlled caster wheel automatically engages and disengages. A sideways force causes the abrasion resistant wheel to disengage to allow rotation, and the direction control indexer automatically returns to the detent position to reengage the abrasion resistant wheel.

In one aspect, an abrasion resistant caster wheel assembly is described. The assembly includes a base mount. The assembly includes a carriage base having a directional control indexer. A caster wheel rotatably engaged to the carriage base. The assembly includes an upper bearing collar, which has a slot to receive the directional control indexer. The assembly includes a lower bearing cap. The carriage base rotates with respect to the upper bearing collar, and the direction control indexer engages to the slot. The directional control indexer may include a spring-loaded ball that engages with the slot in a temporary or removable fashion to release the carriage base to rotate.

### BRIEF DESCRIPTION OF DRAWINGS

FIG. 1 is a side sectional view of the single post bolt embodiment of the abrasion controlled caster wheel.

FIG. 2 is a side sectional view of the welded flange embodiment of the abrasion controlled caster wheel.

FIG. 3 is a side sectional view of the four bolt flange embodiment of the abrasion controlled caster wheel.

FIG. 4A is an exploded view of the four post flange embodiment of the abrasion controlled caster wheel.

FIG. 4B is a top view of the base mount of the four post flange embodiment of the abrasion controlled caster wheel.

FIG. 4C is an end sectional view of the base mount of the four post flange embodiment of the abrasion controlled caster wheel.

FIG. 5A is an exploded view of the welded flange embodiment of the abrasion controlled caster wheel.

FIG. 5B is a top view of the base mount of the welded flange embodiment of the abrasion controlled caster wheel.

FIG. 5C is an end sectional view of the base mount of the welded flange embodiment of the abrasion controlled caster wheel.

FIG. 6A is an exploded view of the single post bolt embodiment of the abrasion controlled caster wheel.

FIG. 6B is a top view of the single post bolt embodiment of the abrasion controlled caster wheel.

FIG. 6C is an end sectional view of the single post bolt embodiment of the abrasion controlled caster wheel.

FIG. 7 is a side view of the direction control indexer.

FIG. 8 is a side sectional view of the direction control indexer.

FIG. 9 is a top view of detent barrel mount bracket.

FIG. 10 is a side sectional view of the detent barrel mount bracket.

FIG. 11 is a side sectional view of the upper bearing/indexer collar.

FIG. 12 is a perspective view of the upper bearing/indexer collar.

FIG. 13 is a side view of the upper bearing/indexer collar.

FIG. 14 is a top sectional view of the upper bearing/indexer collar

### DETAILED DESCRIPTION OF INVENTION

An abrasion controlled caster wheel is described, that, when a sideways force is applied to a rear of a grocery, shopping, material, or other cart either during normal operation or when gathered in the parking lot, will allow a rear caster wheel to redirect its direction of travel or mount rigidity rather than scraping sideways across the wheel circumference. This momentary release allows the rear caster wheel to rotate without abrading, eliminating premature circumferential wear or bending the caster carriage base or frame. The invention will allow the grocery shopping or material cart rear caster wheel to turn into the direction of the applied sideways opposing force thus allowing the wheel to rotate without abrading or bending. After the release, the caster wheel rotates and returns to settle back in its rigid position. Normal operation of a grocery shopping or material cart rear caster wheel maintains the rear caster wheel in a straight forward or a reverse position with no ability to allow the wheel to rotate about a vertical axis. With the abrasion controlled caster wheel, the original design operation of the grocery shopping cart rear caster wheel remains the same except it can be interrupted to alter the direction or to rotate about a vertical axis. Once a straight forward or reverse re-direction is established, the abrasion controlled caster wheel will then allow the rigid caster wheel control to be re-established by the user into a rigid guided direction, using normal user forces to the grocery shopping cart.

The abrasion resistant caster wheel assembly includes a base mount that engages with the cart and with a carriage base. The carriage base rotates relative to the base mount. The carriage base has a directional control indexer. A caster wheel is engaged to the carriage base. The assembly includes an upper bearing collar, which has a slot or opening to receive the directional control indexer. The upper bearing collar is fastened to the base mount in a fixed position. The assembly includes a lower bearing cap. The carriage base rotates with respect to the upper bearing collar, and the direction control indexer engages to the slot of the upper bearing collar. The directional control indexer may include a spring-loaded ball that engages with the slot in a temporary or removable fashion to release the carriage base to rotate. The directional control indexer maintains the position of the carriage base until a force applied to the cart overcomes the force of the directional control indexer allowing the carriage base to rotate.

The abrasion controlled caster wheel allows the wheel and carriage to rotate about the vertical axis rather than abrade the wheel circumference of the rear shopping cart caster wheels. The abrasion controlled caster wheel incorporates the agility of the swivel caster wheel while maintaining the functionality of the rigid rear caster wheel. The abrasion controlled caster wheel utilizes a collar with an upper bearing race and a cutout, detent, opening, etc. on its periphery. The collar is locked into the straight rigid position of the caster wheel base. The cutout of the collar provides the location for the direction control indexer to stop rotation of the caster wheel about the vertical axis holding the caster wheel in a rigid position. The direction control indexer with a spring loaded ball is located in an integral bracket mounted on the carriage base. The direction control indexer rotates freely about collar until the ball falls into the cutout of the collar, holding the wheel and carriage in the rigid straight position. The direction control indexer settles back to a locked position with the ball in the cutout and holding the caster wheel in the forward position. The ball of the direction control indexer holds the carriage base in a straight forward or backward direction. Applying a sideways force to the grocery shopping cart forces the direction control indexer to release from the cutout, allowing the wheel and carriage to turn freely into the direction of the desired force applied travel. The wheel and carriage are free to rotate about the vertical axis until the ball of the direction control indexer drops back into the cutout of the collar. The ease and freedom of the ball of the direction control indexer to fall into and out of the cutout eliminates the abrasion that would have otherwise occurred due to the wheel circumference skidding and abrading sideways across the store floor or asphalt parking lot rather than rolling in the forced direction.

The abrasion controlled caster wheel uses low cost steel stamped parts and material to intentionally release the rear caster wheel from the rigid straight position. The intentional release of the caster wheel from its straight position by applying a sideway force to the grocery shopping cart handle will allow the carriage base to be redirected into any direction other than the rigid straight forward direction of the caster wheel. Allowing redirection of the rear caster wheel eliminates the abrading or scraping of the wheel surface by allowing the wheel to roll rather than scrape across the surface. When the rear caster wheel is held in the rigid position rather than turning into the direction of the applied force on the grocery shopping cart handle, the carriage base and wheel, skid and/or abrade when forced sideways into the direction of forced travel across the asphalt, concrete or store floor.

The abrasion controlled caster wheel provides for the intentional release of directional control with inexpensive light gauge steel stamped parts already in use, for mass produced, low cost caster wheels. The gauge of the stamped parts is dependent upon the desired load carrying capacity of the caster wheel (usually 10 or 11 gauge material).

The base mount attaches or connects to a frame of the cart. The carriage base rotates relative to the base mount. The base mount may include a variety of shapes and configurations to engage the abrasion controlled caster wheel to the frame of the cart. The base mount may include a rectangular, square, round, other shaped structure. The base mount may be engaged to the frame using one or more bolts, weld, etc.

Various of examples of the base mount will now be described:

A four bolt base mount will now be described. This base mount includes a rectangular shape that is bolted to a flat mounting surface of the cart. This base mount may include a rectangular steel stamped base mount with four elongated holes located within the four corners of the rectangular mount.

A single bolt base mount will now be described. This base mount provides the ability to use a single bolt method of securing the abrasion controlled caster wheel to a flat metal portion of the carts. This base mount may include a variety of shapes, such as square or circle. The single bolt passes through a central opening or hole of the base mount. The single bolt base mount may be made from stamping a light gauge steel.

A welded flange base mount will now be descried. This base mount includes a rectangular shape with folded sides. The folded sides are welded to the shopping cart tubular frame. The welded flange base mount may be made from light gauge steel that is stamped into a generally rectangular shape with the sides of the base folded upward or in a circular shape point upward. The folded sides are welded directly to the shopping cart tubular frame.

The various base mounts may connect to the carriage base in a similar manner. The base mounts include a conical stamping forming a depression or lower region in the base mount. The conical stamping includes an upper base and lower vertex diameters of a size to permit strict adherence to dimensional tolerances. The conical steel stamping will have an upper diameter sufficient in size to allow an easy transition to the vertex of the conical lower base and culminate at an apex depth sufficient enough to provide a base land with a hole of an adequate diameter for the installation of the assembly axis threaded bolt. The vertex of the conical stamping should have a depth and width dimensionally sufficient to allow clearance for the installation of a locking retaining axis threaded bolt nut. Located on the inside radius of the steel conical stamping, midway between the steel base mount surface and the vertex base of the conical stamping, will be a protrusion, left as a result of the steel stamping. The protrusion will run top to bottom lengthwise from the surface of the mount base to the stamped vertex conical base. The protrusion will be of such length and depth as to allow stacking of a mating part, namely the upper bearing race/detent collar. The protrusion may have a rectangular, square, ovular, or other shape to facilitate the locking with the upper bearing/detent collar to the base mount. The height of the protrusion will face toward the rectangular portion of the steel stamped base mount. This protrusion provides the index for the alignment of rigid straight forward/reverse directional control. The conical stamping may be located approximately one third of the distance from one end of the base mount. The conical stamping may be centered within the base mount.

This conical stamping is common to all base mounts of the abrasion controlled caster wheel. The conical steel stamping sets the alignment of the caster wheel to the rigid straight position. The conical steel stamping will have an upper diameter sufficient in size to allow an easy transition to the vertex of the conical lower base and will culminate at an apex depth sufficient enough to provide a base land with a hole of sufficient diameter for the installation of the assembly axis threaded bolt.

The conical stamping may also include a protrusion or other feature, such as a directional indicator, to ensure proper alignment of the abrasion controlled caster wheel to the other wheels used on the cart. This promotes an accurate installation of the caster wheel. In some aspects, “V” shaped cutouts are formed in the base mount approximately 180 degrees opposite each other and in a line parallel to the protrusion located within the conical recessed stamping and the center of the assembly axis threaded bolt hole. These “V” cutouts will indicate the straight alignment direction to the installer. These “V” cutouts may be formed on a circumference of a circular base mount or at a perimeter of a square or rectangular base mount.

The abrasion controlled caster wheel includes the upper bearing race/detent collar, which provides for the upper bearing race, as well as a method to locate the upper bearing race/detent collar in proper alignment with the mount base for rigid straight direction control of the abrasion controlled caster wheel. The upper bearing race/detent collar is common to all abrasion controlled caster wheel attachment methods. The upper bearing race/detent collar may be formed from inexpensive light gauge stamped steel. The upper bearing race/detent collar may be stamped from a single sheet of material of sufficient thickness and durability to serve as a bearing surface as well as an indexing media. The upper bearing race/detent collar is conical in shape. The conical stamping will provide the upper bearing race on the underneath side, and around the perimeter of the conical stamping, along with a vertical indexing collar around the outer circumference of the upper bearing race. Upper ball bearings are located below a surface of the upper bearing race. Located within the perimeter vertical collar will be the cutout to provide the rigid alignment index for the abrasion controlled caster wheel.

The upper bearing race/detent collar is stamped into a conical shape to match the conical shape of the base mount plates. The conical shape of the upper bearing race/detent collar should be enlarged sufficiently to snugly receive a male portion of the base mount plate conical surface. Located on the inside radius of the steel conical stamping of the upper bearing race/detent collar, midway between upper bearing race surface and the vertex of the conical stamping, will be a protrusion left as a result of the steel stamping. The protrusion, vertical within the conical surface, will be sized as to fit snugly within the protrusion provided in the base mount. This protrusion will fit snugly inside the rectangular or round base mount protrusion when the caster wheel is assembled and nestled together, establishing the base mount and upper bearing race/detent collar to be in sync with each other.

The upper bearing race/detent collar includes the upper bearing race stamped into its underneath surface. This upper bearing race will be the upper race surface for upper bearings.

Located within the indexing collar is a vertical cutout, approximately 180 degrees opposite the protrusion on the inside radius of the steel conical stamping. This cutout will be provided for the rigid straight forward position of the caster wheel. An additional vertical cutout in the indexing collar may be provided 180 degrees opposite the initial indexing cutout if there would be the desire to have the caster wheel to be rigid in either the forward or reverse position. At the vertex of the conical stamped bearing race will be a flat surface of the size to fit snugly over the flat surface of the base of the conical stamping of the rectangle or round base mount. A hole is stamped with a diameter sufficient for the installation of the threaded axis bolt in the vertex flat area. When assembled with the base mounting plate, the upper bearing race/detent collar will fit snugly together with base mounting plate and the base mounting plate indexing protrusion, providing alignment of the rectangular and round mounting base with the upper bearing race/detent collar.

The abrasion controlled caster wheel includes a carriage base that provides for two arms to be perpendicular to the carriage base with a hole at each end of the arms for the installation of the caster wheel. The carriage base will provide for the lower bearing race surface for the upper ball bearings and the upper bearing race surface for the lower ball bearings. A direction control mounting flange is located on the same plane as the carriage base and is perpendicular to the carriage base. The carriage base provides for the rotating portion about the vertical axis of the abrasion controlled caster wheel.

The abrasion controlled caster wheel may include the carriage base that incorporates the carriage legs, an indexer mount bracket to mount a direction control indexer, as well as provide the lower ball bearing race surface for the upper ball bearings and the upper ball bearing race surface for the lower ball bearings. The carriage base may be formed from a light gauge piece of a steel pattern stamped out to cut the outline of the one piece carriage base. The initial stamping provides a blank, locating the functional areas of the upper and lower bearing races on the carriage base, the carriage base arms, and the direction control indexer mount flange.

The carriage base is stamped to form the lower ball bearing race of the upper ball bearing and the upper ball bearing race for the lower ball bearings. The carriage base is common to both the upper indexing bearing and the lower carriage bearing. Centered in the carriage base, within the bearing race provisions, will be a hole sized large enough so as to not allow the carriage base to interfere with the upper bearing race/detent collar and the lower bearing race when assembled. Once assembled, the carriage base should turn freely when both the upper and lower ball bearings are loaded to a defined torque.

Integral to the steel stamped blank provided for the stamping of the carriage base, the direction control indexer portion of the steel stamped blank will be stamped with a hole sized for the mounting of the direction control indexer, with two small holes stamped on each side of the direction control indexer mounting hole. The direction control indexer mounting flange may be formed in a secondary stamping operation. The direction control indexer flange is formed perpendicular to the carriage base with the center of the direction control indexer mount holes located on a plane even with the carriage base.

The carriage legs also will be pre-stamped with two holes located at the tips of the carriage legs for the axle bolt of the carriage wheel. The carriage legs will be formed with the carriage legs perpendicular to the carriage base and extending down a designated length and offset to the center of the carriage base to facilitate the installation of the carriage wheel. The axle hole located at the end of the carriage leg is located offset from the center of the of the assembly axis bolt. The offset distance of the centerline of the wheel axis should be no less than one-third of the diameter of the wheel or more than one-half of the diameter of the wheel from the vertical axis of the abrasion controlled caster assembly axis bolt.

The initial blank is stamped into the formation to provide for a carriage base that incorporates two vertical conically shaped arms beginning at the outer area of the carriage base and as straight vertical as possible in order to provide a release of the stamping machine.

The carriage base includes the lower race for the upper bearings and the upper race for the lower bearings. The lower race is used to house the upper ball bearings. A flat securing surface is formed inside of the lower race to facilitate the retention of the abrasion controlled caster wheel assembly. A hole is formed in the carriage base, central to the lower race and the upper race, that is sufficient in size to provide for the insertion of the swivel axis through bolt of the abrasion controlled caster wheel.

The abrasion controlled caster wheel includes a direction control indexer that holds the caster wheel in the rigid straight forward position and to release when a force is applied in a direction other than straight forward, eliminating scuffing and abrading of the caster wheel. The barrel of the direction control indexer is made of brass or stainless steel to retard corrosion and consists of the following: the main barrel is hollow and threaded on the inside of one end to provide the threads needed to insert a threaded plug. The opposite inside end of the barrel is reduced in size at the opening to an inside diameter less than the diameter of the indexer ball. The outside of the barrel, located on the opposite end from the inside threaded portion of the barrel, is threaded to accommodate securing the barrel to the threaded direction control indexer mount bracket. Located within the barrel and opposite the threaded end plug of the barrel is the indexing ball. The indexing ball, when forced into the indexing slot of the upper bearing race/detent collar, holds the carriage base rigid in the straight forward/reverse position. Located internally in the barrel, behind the ball, is a coil spring with adequate tension capability to load the indexing ball with a force sufficient to retain the carriage base in the straight forward or reverse position but insufficient to hold the carriage base in a straight position, eliminating the scuffing or abrading to the wheel, and allowing the wheel to release into the forced direction. A threaded plug is flat on one side and slotted on the other to allow adjusting the depth of the insertion of the plug. The threaded plug screws into the end of the barrel and provides the surface area required to apply pressure against the internal spring that in turn applies the pressure against the indexing ball. If additional tension or pressure is required, the threaded plug can be screwed in or out as needed to adjust spring tension.

A separate mount bracket, drilled or hole stamped and tapped to receive the threaded mounting end of the barrel of the direction control indexer is provided. The mount bracket has two small screw mount holes approximately 180 degrees opposite each other, one on each side and center of the threaded barrel mounting hole. The two mount holes are spaced to match the mounting holes in the direction control indexer mount flange located on the carriage base. The use of machine screws or self-tapping screws can be used to fasten the direction control indexer barrel mount bracket to the flange located on the carriage base.

Sideways force applied to the abrasion controlled caster wheel controls the directional aspect of the abrasion controlled caster wheel by allowing the force applied to release a directional control indexer. Once the direction control indexer is released, the abrasion controlled caster wheel is allowed to turn into the direction of the force applied, negating the abrasion or premature circumferential wear to the wheel. When the force applied to the grocery shopping cart pushes the grocery shopping cart forward, the forward force causes the rear caster wheel to once again relocate to the forward and natural rigid position by the direction control indexer. When a force is applied contrary to forward or reverse direction, the abrasion controlled caster wheel will spin on its axis rather than abrading because the direction control indexer releases from the detent locked straight position. When abrupt heavy sideways and downward forces are applied, upsetting of the grocery shopping cart such as in a parking lot or hitting a curb, the direction control indexer allows the instant release of the carriage base or frame. Once released, the carriage base frame will turn rather than to be forced to absorb the blow or the force applied which the carriage base was not designed to absorb. Without the use and activation of the direction control indexer, the rear rigid caster wheel will develop flat spots along the circumference of the rear rigid caster wheel. A rear rigid caster wheel that has a flat spot or multiple flat spots due to the rigid caster wheel's inability to turn in to the direction of travel is irritating and disappointing to the user who has to push this grocery shopping or material cart throughout the store. Using an abrasion controlled caster wheel, the maintenance of the grocery shopping cart is drastically reduced, since now replacement of the rear rigid caster wheel due to flat spots and premature circumferential wear as well as bent carriage base or frame is corrected. The abrasion controlled caster wheel eliminates this inconvenience to the customer and the costly maintenance for the store owner. Store operations using abrasion controlled caster wheels will now require fewer grocery shopping or material carts as the number of grocery shopping carts shipped or stored for repair is reduced.

The caster wheel described herein provides the momentary control of the rear caster wheel. This invention provides the means to eliminate the excessive abrasion to the rear rigid caster wheels and to eliminate the flat spots caused from an irregular sideways force that causes flat spot on the wheel. Elimination of the flat spots in turn eliminates the annoying thumping noise that the shopping cart user has to endure as the wheel turns when the grocery shopping cart is pushed throughout the store. By combining the engineering design characteristics of the front swivel caster wheel and the rear rigid caster wheel into the caster wheel described herein, the abnormal wear to the rigid rear caster wheel of the grocery shopping carts will be eliminated. The fatigued store employee will no longer have to overcome the resistance of the line of stacked grocery shopping carts to change direction of travel when needed to navigate the carts back to the store storage area. Wheel replacement will be greatly reduced and damaged or bent carriage legs will be eliminated.

The design of the abrasion controlled caster wheel allows the abrasion controlled caster wheel to be used as a plain and simple swivel caster wheel by merely leaving the direction control indexer uninstalled. Without the direction control indexer, the abrasion controlled caster wheel is unable to be held in a rigid straight forward/reverse position.

The design of the abrasion controlled caster wheel allows the rear caster wheel, while in a rigid position, to yield to a minimal forced direction by the user of the grocery shopping or materials cart. Three embodiments of the abrasion controlled caster wheel are described below that accommodate various methods for attaching the abrasion controlled caster wheel to the cart. A four bolt flange mount version 10C is similar to a weld mount version 10B and a single post bolt mount version 10A. All three embodiments show the direction control indexer 100 relationship to a caster wheel 15.

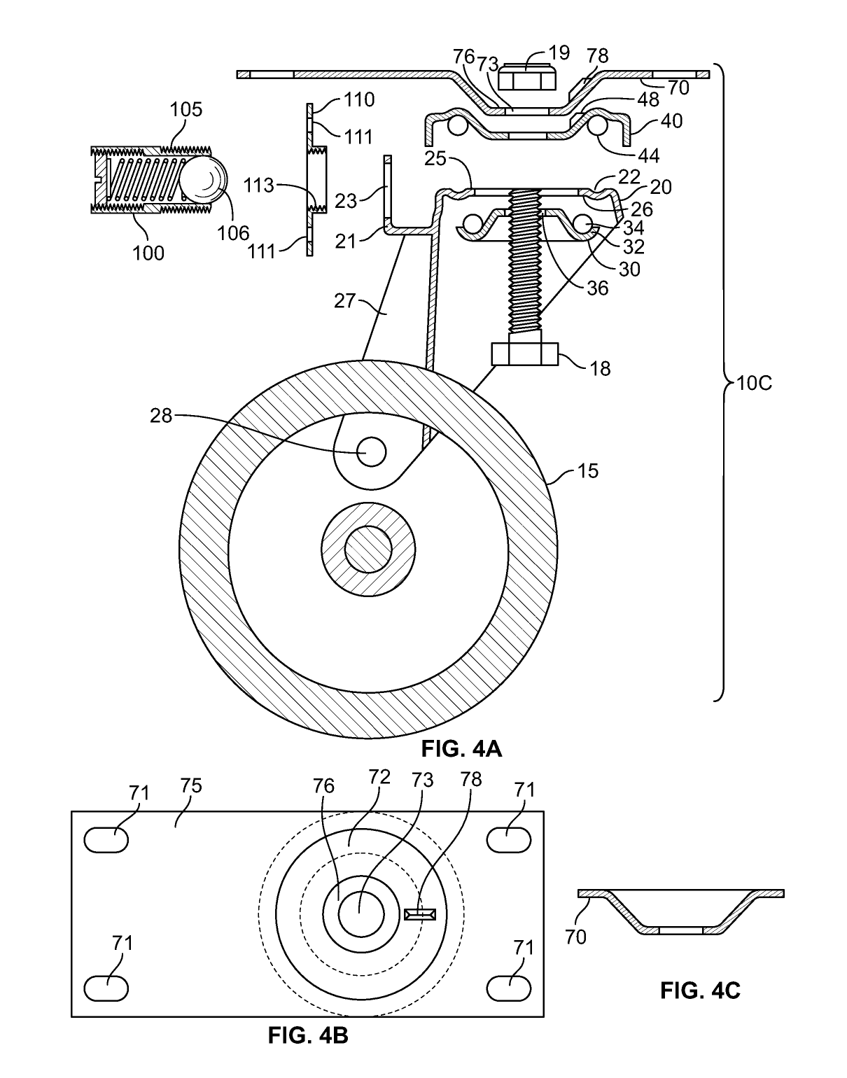

With respect to FIGS. 3 and 4A-4C, the four bolt flange mount 10C is shown. The four bolt flange mount 10C is similar to the weld mount 10B and the single post bolt mount 10A abrasion controlled caster wheel except for the method of attachment. The four bolt flange mount 10C starts with an appropriate gauge thickness blank forming a base mount 70 that is stamped into a rectangle having four elongated holes 71 in the corners with a conical recess area 72 with a center hole 73 through the conical recessed area 72 to facilitate the passage of an assembly axis threaded thru bolt 18. A depth of the conical recessed area 72 will be of sufficient depth to conceal the assembly axis bolt nylock nut 19. Located within the conical recessed area 72, vertical and midway between the conical vertex and a base flange 76, is a protrusion 78. In certain aspects, the protrusion 78 may be approximately ⅛″ in height and approximately ⅜″ in length. The protrusion 78 will be located parallel to the center line of the length of the mount base 70 and to the one-third end of the mount base 70. The protrusion 78 serves as the locking indicator for the direction control indexer 100 when the upper bearing/detent collar 40 is installed. The protrusion 78 may include a rectangular, square, ovular, or other shape to facilitate the locking with the upper bearing/detent collar 40.

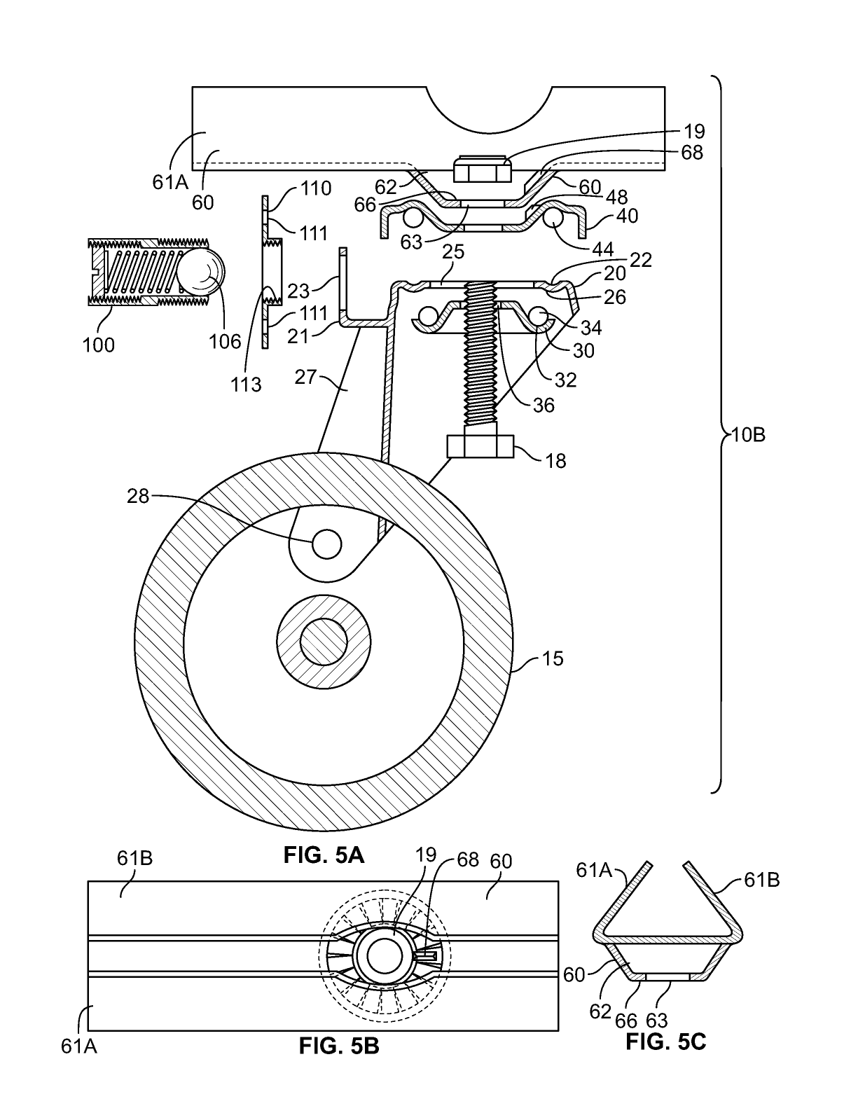

With respect to FIGS. 2 and 5A-5C, the weld flange mount 10B is shown. The weld flange mount 10B starts with an appropriate gauge thickness blank that is stamped into a rectangle forming a base mount 60 having a conical recess area 62 with a center hole 63 through the conical recessed area 62 to facilitate the passage of the assembly axis threaded thru bolt 18. Two opposite sides 61A and 61B are formed into angles that allow the formed legs to locate against a tubular frame 5 and the cart. The depth of the conical recessed area 62 will be of sufficient depth to conceal the assembly axis bolt nylock nut 19. Located within the conical recessed area 62, vertical and midway between the conical vertex and the base flange 66 is a protrusion 68. The protrusion 68 may be ⅛″ in height and ⅜″ in length. The protrusion 68 will be located parallel to the center line of the length of the mount base and to the one-third end of the mount base. The protrusion 68 serves as the locking indicator for the direction control indexer 100 when the upper bearing/detent collar 40 is installed. The protrusion 68 may include a rectangular, square, ovular, or other shape to facilitate the locking with the upper bearing/detent collar 40.

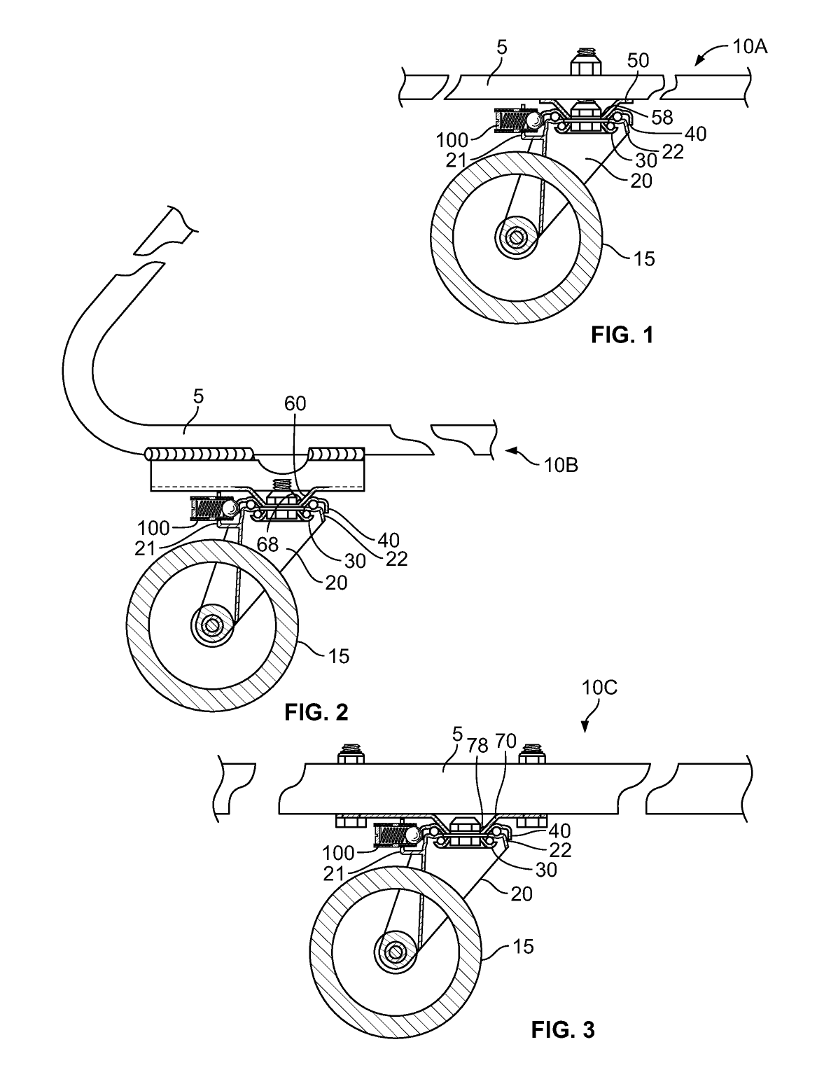

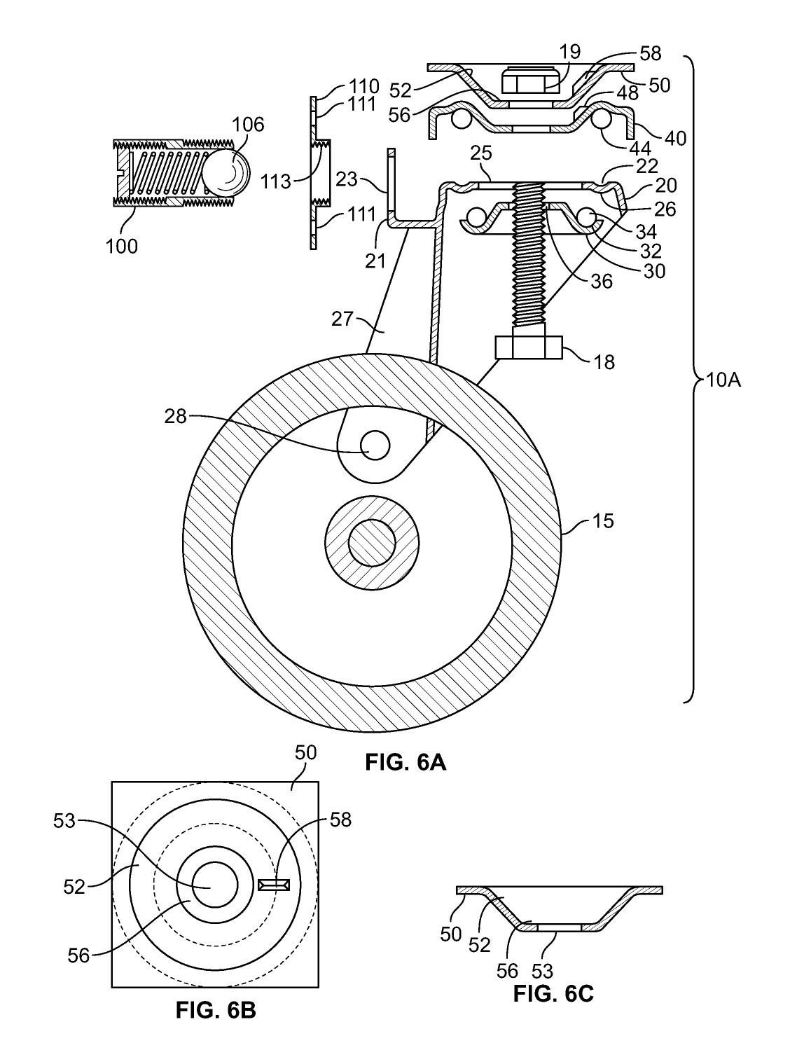

With respect to FIGS. 1 and 6A-6C, the single post mount 10A is shown. The single post mount 10A starts with an appropriate gauge thickness blank that is stamped into circular blank forming a base mount 50 having two v-notches opposite each other and in line with the straight position of the abrasion controlled caster wheel 10. The circular stamping will also have a conical recess area 52 with a center hole 53 through the conical recessed portion to facilitate the passage of the assembly axis threaded thru bolt 18. The depth of the conical recessed area 52 will be of sufficient depth to conceal the assembly axis bolt nylock nut 19. Located within the conical recessed area 52, vertical and midway between the conical vertex and the base flange 56 is a protrusion 58. The protrusion 58 may be ⅛″ in height and ⅜″ in length. The protrusion 58 will be located parallel to the center line of the length of the circular mount base V-notches. The protrusion 58 serves as the locking indicator for the direction control indexer 100 when the upper bearing/detent collar 40 is installed. The protrusion 58 may include a rectangular, square, ovular, or other shape to facilitate the locking with the upper bearing/detent collar 40.

With respect to FIGS. 11-14, the upper bearing/detent collar 40 is shown. The upper bearing/detent collar 40 is formed from a circular steel blank of appropriate gauge thickness. The steel is stamped into a circular blank with a detent cutout slot 42 in a circumference 43 of the collar 40. The slotted blank is steel stamped formed to provide a circular vertical collar about the circumference along with a conical surface to match the conical recess of the three types of mount bases 10A, 10B, and 10C.

Located on the inside radius of the steel conical stamping of the upper bearing/detent collar 40, midway between a steel base mount surface 45 and the vertex base of the conical stamping, will be a protrusion 48, left as a result of the steel stamping. The protrusion 48 may include a rectangular shape. The protrusion 48 will run top to bottom lengthwise from the surface of the mount base to the stamped vertex conical base. The protrusion 48 will be of such length and depth on the upper bearing/detent collar 40 as to allow stacking of a mating part, namely the respective base mount flange 50, 60, or 70. The height of the protrusion 48 will face toward the recessed portion of the steel stamped base mount. This protrusion 48 provides the index for the rigid straight forward/reverse directional control. The protrusion 48 has a complementary shape to the protrusions 58, 68, or 78 to engage with the protrusions 58, 68, or 78. The protrusion 48 may include a rectangular, square, ovular, or other shape to facilitate the engagement between the upper bearing/detent collar 40 and the respective base mount flange 50, 60, or 70.

Upper bearings 44 are positioned between the upper bearing race/detent collar 40 and the carriage base 20. Lower bearings 34 are positioned between the carriage base 20 and a lower bearing race cap 30.

The carriage base 20 is stamped to form a lower bearing race 22 for the upper bearings 44 positioned by the race/detent collar 40 and to form the upper bearing race 26 for the lower bearings 34. Carriage legs 27 are formed during the steel stamping, leaving wheel axle bolt holes 28 perpendicular to the carriage base 20.

The lower bearing race cap 30 is formed to provide a lower ball bearing race 32 for the lower bearings 34. A hole 36 for the insertion of the assembly axis thru bolt 18 is stamped center in the lower bearing race cap 30.

The assembly axis thru bolt 18 and along with the assembly axis nylock nut 19 is used to both assemble and load torque the assembled abrasion controlled caster wheel 10A, 10B, and 10C to a specific torque. The assembly axis thru bolt 18 serves as the center vertical axis of the abrasion controlled caster wheel 10A, 10B, and 10C as well as retention of all parts into an abrasion controlled caster wheel assembly.

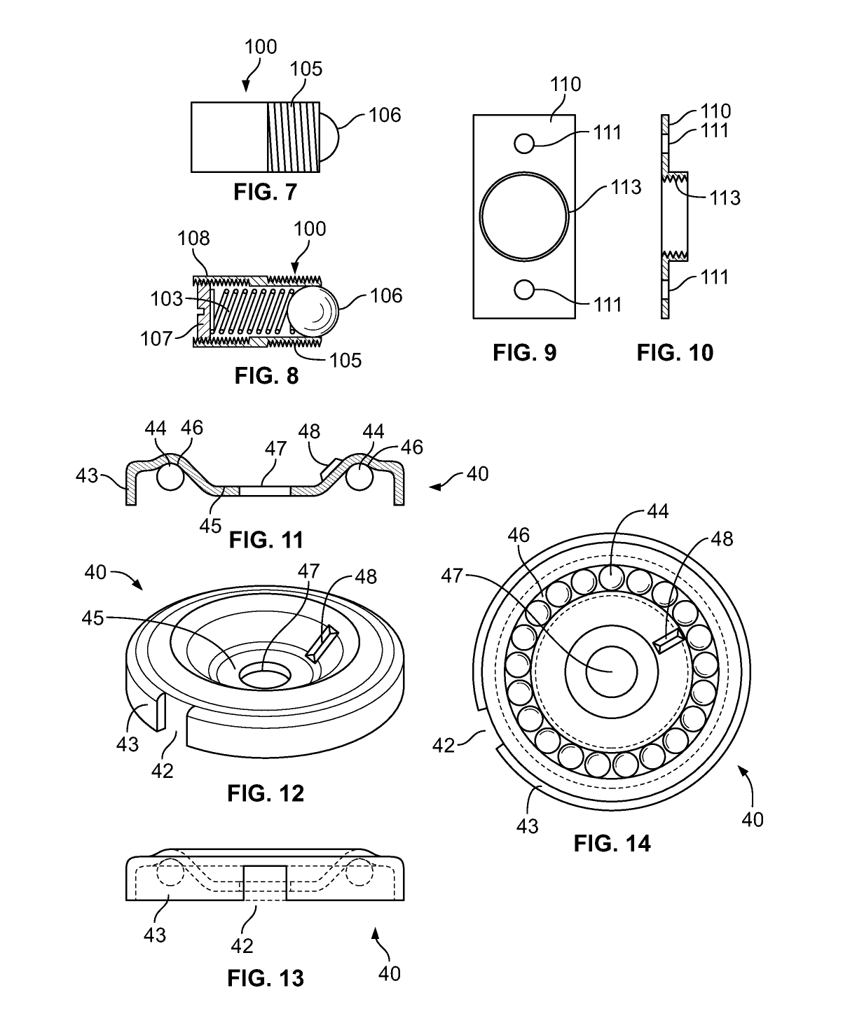

With respect to FIGS. 7 and 8, the direction control indexer 100 is shown. With respect to FIGS. 9 and 10, a detent barrel mount base 110 is shown. The detent barrel mount bracket 110 holds the direction control indexer 100. The detent barrel mount base 110 is affixed, attached or integral with a direction control indexer mount bracket 21. The direction control indexer mount bracket 21 is located on the carriage base 20. The direction control indexer mount bracket 21 provides the mounting location for the direction control indexer 100. The direction control indexer mount bracket 21 is formed to a 90 degree angle to an upper surface 25 of the carriage base 20. A detent barrel mount bracket hole 23 is located within a perpendicular portion of the direction control indexer mount bracket 21. Two holes 111 are located either side of the detent barrel mount base 110 are used to secure to the direction control threaded indexer mount bracket 21 using self-taping machine screws. The large threads allow the barrel 105 of the direction control indexer 100 to secured to the direction control indexer mount base 110.

The direction control indexer 100 is the mechanism used to lock the abrasion controlled caster wheel 10A-C into the rigid straight direction position. The direction control indexer 100 is secured into the direction control indexer barrel mount base 110 by screwing the direction control indexer barrel 105 into a threaded opening 113 of the direction control indexer mount base 110 and securing the direction control indexer barrel mount base 110 to the direction controlled indexer mount bracket 21 using self-tapping machine screws.

The direction control indexer 100 maintains the rigid position of the abrasion controlled caster wheel 10. The direction control indexer 100 includes the barrel 105, which is made of brass or stainless steel to retard corrosion. The main barrel 105 is hollow and threaded on the inside of one end to provide the threads needed to insert a threaded plug 107. The opposite inside end of the barrel 105 is reduced internally in size at the opening to an inside diameter less than the diameter of an indexer ball 106, which may be made from stainless steel or other corrosion resistant metal or metal alloy. The outside of the barrel 105, located on the opposite end from the inside threaded portion of the barrel 105, is threaded to accommodate securing the barrel 105 to the threaded direction control indexer barrel mount base 110. Located within the barrel 105 and opposite the threaded end plug 107 of the barrel 105 is the indexing ball 106. The indexing ball 106, when forced, due to spring tension, into the indexing slot 42 of the upper bearing race/detent collar 40, holds the carriage base 20 rigid in the straight forward/reverse position. Located internal of the barrel 105, behind the ball 106, is a coil spring 103 with adequate tension capability to load the indexing detent ball 106 with a tension of sufficient force to retain the carriage base 20 in the straight forward or reverse position. This tension is designed as to be not strong enough to hold the carriage base 20 in a straight position when the user of the grocery shopping cart applies a sideways force to the grocery shopping cart. Allowing the detent ball 106 to release from the upper bearing/detent collar 40, allows the carriage base 20 to rotate, eliminating the scuffing or abrading to the wheel 15. Upon a sideways force, the detent ball 106 automatically disengages, without the user manually touching the caster wheel 10A-C, from the indexing slot 42 of the upper bearing race/detent collar 40 to allow the carriage base 20 to rotate. As the carriage base 20 rotates, it automatically reengages the detent ball 106 to the indexing slot 42 to resume a straight-forward position.

A threaded plug 107 is flat on one side and slotted on the other side to allow for the adjusting of the depth of the insertion of the threaded plug 107. The threaded plug 107 screws into the end of the barrel 105 and provides the surface area required to apply pressure against the internal spring 103 which in turn applies the pressure against the indexing ball 106. If additional tension or pressure is required, the threaded plug 107 can be screwed in or out as needed to adjust spring tension pressure of the ball 106 against the slot 42 of the upper bearing/detent collar 40.

The abrasion controlled caster wheel assembly is held together through the centerline of bearings 34 and 44, carriage base 20, and base mount 60, 70, or 80 utilizing a rotating axis rivet pin or assembly axis threaded bolt 18. The assembly axis threaded bolt 18 is tightened to load the upper and lower ball bearing assemblies 30 and 40 of the abrasion controlled caster wheel 10.

Control of the release point of the abrasion controlled caster wheel 10A-C is accomplished by positioning the barrel 105 with the spring-loaded ball 106 against the detent collar forward/reverse position slot 42 located in the upper ball bearing race/detent collar 40. The ease, with which the ball of the direction control indexer 100 is forced out of the upper bearing/detent collar slot 42, is dependent upon the spring tension loaded onto the ball 106 in the direction control indexer 100.

The discussion so far has been directed toward holding the abrasion controlled caster wheel 10A-C in the straight forward position. The abrasion controlled caster wheel 10A-C can also be manufactured in such a way so as to hold the abrasion controlled caster wheel 10A-C in the reverse position as well, utilizing the same forces that are applied to the straight forward position. Allowing the abrasion controlled caster wheel 10A-C to be held in either the forward or reverse straight position merely requires the addition of another detent slot approximately 180 degrees opposite of the detent collar forward position slot 42. While the reverse detent collar slot is not needed to correct the unnatural wear on the rear caster wheel 15, it would allow the shopper to push the grocery shopping cart in a straight line in reverse to the natural direction of the grocery shopping cart, without abrading or scuffing the rubber on the outside diameter of the wheel.

What is claimed is:

1. An abrasion resistant caster wheel assembly, comprising:
a base mount;
a carriage base, the carriage base comprising a directional control indexer;
a caster wheel rotatably engaged to the carriage base;
an upper bearing collar, the upper bearing collar with a slot to receive the directional control indexer;
a lower bearing cap; and,
wherein the carriage base rotates with respect to the upper bearing collar, and the direction control indexer engages to the slot.

2. The caster wheel assembly according to claim 1, wherein the caster wheel assembly holds the caster wheel in a rigid position or in a freely swiveling position.

3. The caster wheel assembly according to claim 1, wherein upper ball bearings are located between a lower surface of the upper bearing collar and an upper surface of the carriage base, wherein lower ball bearings are located between a lower surface of the carriage base and an upper surface of the lower bearing cap.

4. The caster wheel assembly according to claim 1, wherein the directional control indexer is biased to engage the slot of the upper bearing collar to prevent rotation of the carriage base until a force is applied that overcomes the bias of the directional control indexer.

5. The caster wheel assembly according to claim 1, wherein the upper bearing collar is locked in a straight rigid position with respect to the base mount.

6. The caster wheel assembly according to claim 1, wherein the direction control indexer is positioned on a bracket mounted to the carriage base.

7. The caster wheel assembly according to claim 1, wherein the direction control indexer rotates freely about the upper bearing collar until the indexer extends into the slot of the upper bearing collar, and the carriage base is then held in a rigid straight position.

8. The caster wheel assembly according to claim 1, wherein the direction control indexer, includes a barrel, a spring, and a ball.

9. The caster wheel assembly according to claim 8, wherein the direction control indexer forces the ball into the slot of the upper bearing collar.

10. The caster wheel assembly according to claim 8, wherein the spring has adequate tension capability to load the ball with a force sufficient to retain the carriage base in the straight forward or reverse position until a greater force is applied to the carriage base which overcomes the retaining force of the spring and causes the carriage base to rotate which reduces or prevents scuffing or abrading to the wheel.

11. The caster wheel assembly according to claim 1, wherein the upper bearing collar includes a first protrusion that engages with a second protrusion on the base mount to align the base mount and the upper bearing collar.

12. The caster wheel assembly according to claim 1, wherein the carriage base is locked semi-rigidly in a forward or reverse direction.

13. The caster wheel assembly according to claim 1, wherein a bearing collar is rigidly mounted to the base mount; the directional control indexer engages to the bearing collar at a first position; and, wherein the carriage base rotates with respect to the bearing collar, and the direction control indexer is tensioned to the hold the carriage base at the first position until a greater force is applied to the carriage base.

14. A grocery cart comprising the caster wheel assembly according to claim 1.

15. The grocery cart according to claim 14, wherein the caster wheel assembly is mounted to rear of the grocery cart.

16. The grocery cart according to claim 15, wherein a sideways force applied to the rear of the grocery cart will cause the caster wheel assembly to rotate rather than scraping sideways across a wheel circumference of the caster wheel.

17. A semi-rigid caster wheel assembly, comprising:
a base mount;
a carriage base, the carriage base comprising a directional control indexer;
a caster wheel rotatably engaged to the carriage base;
a bearing collar,
the directional control indexer engages the bearing collar at a first position and at a second position, wherein the first position and the second position are approximately 180 degrees apart on a diameter of the bearing collar;
wherein the first position and the second position are openings, slots, detents, or cut-outs in the diameter of the bearing collar; and,
wherein the carriage base moves between a rigid configuration where the directional control indexer engages the bearing collar at the first position and at the second position and a swiveling configuration where the directional control indexer moves against the diameter of the bearing collar.

18. A shopping cart comprising the semi-rigid caster wheel assembly according to claim 17.

19. An abrasion controlled, semi-rigid caster wheel assembly, comprising:
a base mount;
an upper bearing collar, the upper bearing collar with a slot to receive a directional control indexer;
a carriage base, the carriage base comprising a bracket, and the directional control indexer is mounted to the bracket, wherein the carriage base rotates relative to the base mount and the upper bearing collar, and the directional control indexer is biased to engage the slot of the upper bearing collar to prevent rotation of the carriage base until a force is applies that overcomes the bias of the directional control indexer;
a caster wheel rotatably engaged to the carriage base;
a lower bearing cap;
wherein upper ball bearings are located between a lower surface of the upper bearing collar and an upper surface of the carriage base, wherein lower ball bearings are located between a lower surface of the carriage base and an upper surface of the lower bearing cap; and,
a bolt passes through the lower bearing cap, the carriage base, the upper bearing collar, and the base mount.
